(19) United States
(12) Patent Application Publication
(10) Pub. No.: US 2003/0072481 A1
(43) Pub. Date: Apr. 17, 2003

(54) Method for evaluating anomalies in a semiconductor manufacturing process

(75) Inventors: Christopher L. Wooten, Austin, TX (US); Arturo Morosoff, Austin, TX (US)

Correspondence Address: Rennie W. Dover, Gallagher & Kennedy, 2575 E. Camelback Road, Phoenix, AZ, 85016, US

(73) Assignee: ADVANCED MICRO DEVICES, INC.

(21) Appl. No.: 09/976,739

(22) Filed: Oct. 11, 2001

(51) Int. Cl. G06K 9/00; G06K 9/64

(52) U.S. Cl. 382/145; 382/217

(57) ABSTRACT

A method for determining whether a defect has previously occurred by searching a database of defect spatial signatures for a signature that matches that of a newly inspected semiconductor wafer. If a match occurs, an engineer is notified of the match. The defect spatial signature of the newly inspected wafer is added to the database of defect spatial signatures.

### FIELD OF THE INVENTION

This invention relates, in general, to semiconductor manufacturing processes and, more particularly, to identifying process signatures of the semiconductor manufacturing process.

### BACKGROUND OF THE INVENTION

It is well known that integrated circuits and discrete semiconductor devices are manufactured using a series of process steps. A typical semiconductor process flow may involve more than one hundred process steps including processes such as lithography, etching, doping, oxidation, planarization, metallization, passivation, and cleaning, among others. Although the process steps for manufacturing integrated circuits have been well characterized, a significant number of defects still appear on the semiconductor wafers. Events capable of causing these defects include, but are not limited to, particle contamination, scratching, polishing anomalies, wafer spinning processes, watermarks, particle stains, and micro-scratching. Making matters worse, semiconductor manufacturers are increasing the density of devices per die and increasing the size of the wafers to increase the number of die per wafer. Thus, a few defects on a wafer can significantly decrease the die yield on the wafer.

Hence, semiconductor manufacturers have incorporated inspection techniques using optical image devices capable of discerning unique defect patterns on a wafer surface, commonly referred to as defect spatial signatures. FIG. 1 is a wafer map 10 showing random defects on a semiconductor wafer. It should be noted that the distinguishing feature of a wafer map having random defects is the absence of any type of pattern or any defect spatial signatures. A problem with random defects is that finding the cause of the defects is extremely difficult. FIG. 2 is a wafer map 15 of a semiconductor wafer having a defect spatial signature caused by, for example, a wafer spinning process. Although the optical image devices allow engineers to view the defect spatial signatures on a wafer, it is difficult for engineers to remember all the types of defect spatial signatures they have seen and associate a particular signature with a particular process step or piece of process equipment.

Accordingly, what is needed is a method to enable engineers to review a defect spatial signature and associate the signature with a specific process step or piece of process equipment.

### SUMMARY OF THE INVENTION

The present invention satisfies the foregoing need by providing a method for performing defect spatial signature analysis. In a preferred embodiment, defect information and the associated identification information are stored in a relational database. A defect spatial signature for a newly inspected wafer is generated and the relational database is searched to determine if the new defect spatial signature matches any of the defect spatial signatures in the relational database. If a match occurs, the engineers are notified. The defect information and its associated wafer identification information are stored in the relational database.

### BRIEF DESCRIPTION OF THE DRAWING

The present invention will be better understood from a reading of the following detailed description, taken in conjunction with the accompanying drawing figures in which like references designate like elements and in which:

FIG. 1 is a wafer map lacking a defect spatial signature;

FIG. 2 is a wafer map illustrating a defect spatial signature;

FIG. 3 is a flow chart of a process for performing defect spatial signature analysis in accordance with an embodiment of the present invention; and

FIG. 4 is a wafer map illustrating a defect spatial signature having a clustering boundary.

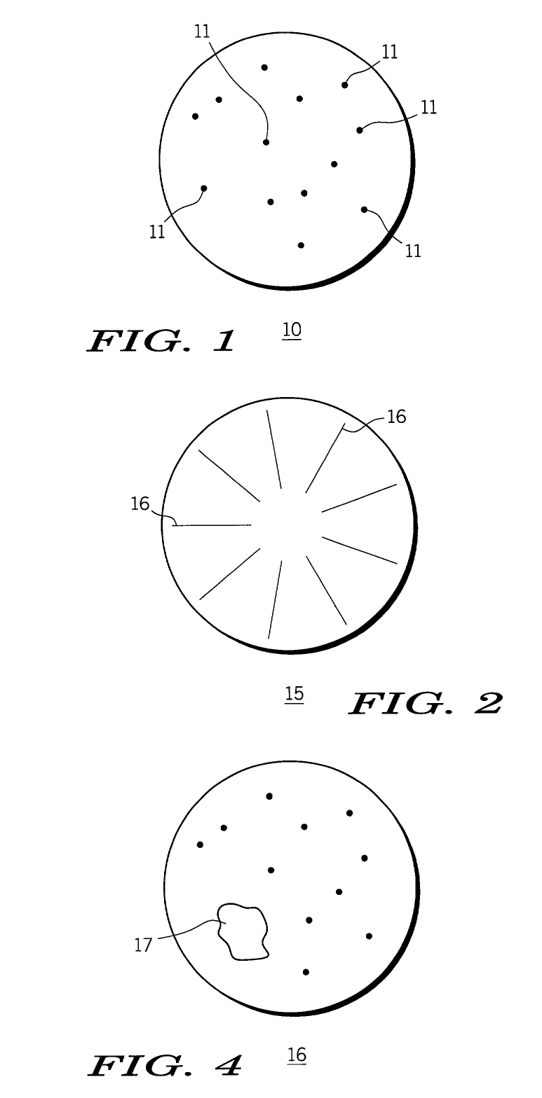

### DETAILED DESCRIPTION

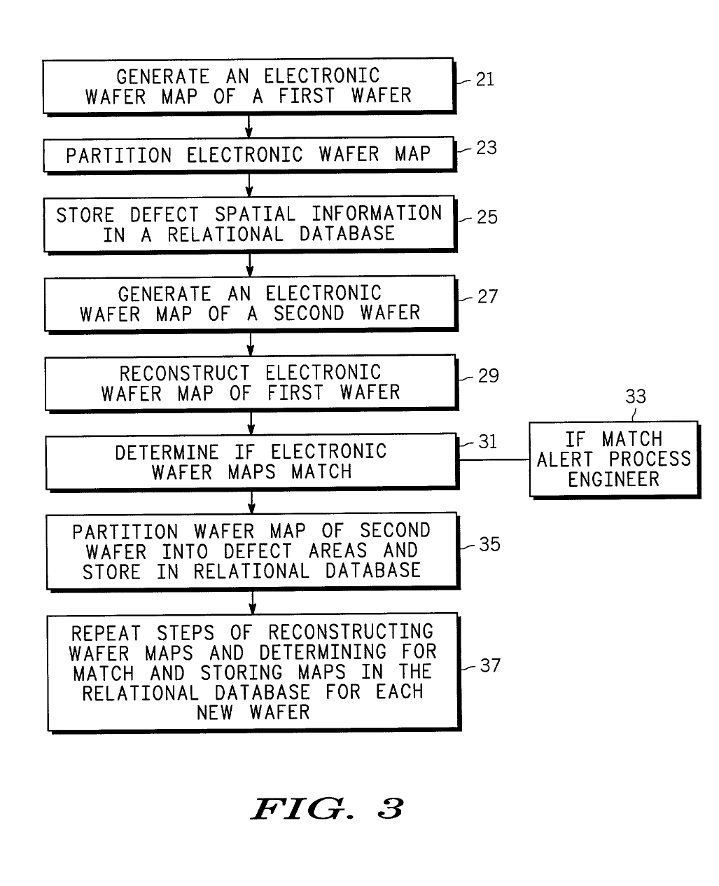

The present invention provides a method for determining whether a particular defect on a semiconductor wafer has been encountered previously. These defects are anomalies caused by anomalous events in the semiconductor manufacturing process. Examples of process steps that can cause defects having defect spatial signatures, include, but are not limited to, particle contamination, mechanical surface damage, wafer spinning processes, scratching, and polishing. This method provides for electronically searching a database to determine if a spatial signature has occurred before and, if so, notifying an engineer. FIG. 3 is a flow chart of a process for performing defect spatial analysis in accordance with an embodiment of the present invention. In a beginning step identified by reference number 21, an electronic wafer map for a first wafer having a defect associated therewith is generated. In a next step (reference number 23), the electronic wafer map of the first wafer is partitioned into defect regions or areas, i.e., the defects are clustered using mathematical clustering techniques or using a stylus and a pad. Briefly referring to FIG. 4, a wafer map 16 of a defect spatial signature having a cluster boundary 17 is illustrated. The clustering is accomplished using a stylus and pad coupled to a computer system displaying an image of the defect spatial signature. By way of example, the defects are caused at a furnace operation in a semiconductor manufacturing process. The wafer map is stored in a relational database (reference number 25), such that the relationship of the defects to each other are stored in a row and column format.

An electronic wafer map of a second wafer is generated (reference number 27). The wafer map of the first wafer is reconstructed from the relational database (reference number 29) and the wafer maps of the two wafers are electronically analyzed to determine if the wafer map of the first wafer correlates to that of the second wafer within a predetermined confidence level (reference number 31). If a match within the predetermined confidence level occurs, then the computer reports that a match has been encountered. The engineer is notified and can then review the process history of the first wafer with that of the second wafer to discover at which step in the process the defect occurred. Using this information, the engineer can take appropriate corrective action to prevent the defect from occurring again (reference number 33).

The electronic wafer map of the second wafer is partitioned into defect areas, which are stored in the relational database (reference number 35), such that the relationship of the defects within the wafer are stored in a row and column format. Similar to the first wafer, wafer identification information of the second wafer is also stored in the computer database. The relational database now includes wafer defect information of the first two wafers and their associated identification information.

As each new wafer map is generated, it is compared with the reconstructed wafer maps present in the relational database to determine if a match exists between the new wafer map and any wafer map existing in the computer database. If a match exists, the engineer is notified and can take an appropriate action. The new wafer map is partitioned into defect areas which, along with its associated wafer identification information, are stored in the relational database (reference number 37).

By now it should be appreciated that a method has been provided for performing defect spatial analysis that is fast, accurate, and economical. The method allows an engineer to sift through large amounts of data in diagnosing process problems without having to rely on their own memories of past occurrences of wafer defects. A particular advantage of the present invention is that it eliminates steps such as categorizing and correlating defect data, thereby saving time for the engineer and the costly step of writing software programs capable of performing the categorization and/or correlation. Thus, the data in the relational database is uncategorized and uncorrelated. Another advantage of the present invention is that it removes the variability inherent in manually analyzing defect spatial signatures, i.e., the present method mitigates the differences in interpretation between two or more engineers. The present method also improves the process flow by providing a means for quickly identifying the causes of defects, thereby improving wafer throughput.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A method for performing defect spatial signature analysis of a semiconductor process, comprising:
creating a defect database of wafers having defect spatial signatures, wherein the defect spatial signatures in the defect database are uncategorized data;
generating a recent defect spatial signature; and
determining if the recent defect spatial signature corresponds to at least one of the defect spatial signatures of the defect database.

2. The method of claim 1, wherein the defect database contains uncorrelated data.

3. The method of claim 2, wherein creating the defect database includes creating a relational database of defects.

4. The method of claim 3, further including storing coordinates of a process signature of a first defect and storing coordinates of a process signature of a second defect, wherein the coordinates of the process signatures of the first and second defects are in relation to each other.

5. The method of claim 3, further including creating a local density of defects for each wafer using one of a mathematical formulation or a stylus and a pad.

6. The method of claim 1, further including adding the recent defect spatial signature to the defect database.

7. The method of claim 1, further including adjusting a process if the recent defect spatial signature corresponds to at least one of the defect spatial signatures of the defect database.

8. The method of claim 1, wherein creating the defect database includes:
creating a relational database of defects; and
storing coordinates of a process signature of a first defect and storing coordinates of a process signature of a second defect, wherein the coordinates of the process signatures of the first and second defects are relative to each other.

9. The method of claim 1, wherein the defect spatial signatures are from at least one of particle contamination, mechanical surface damage, wafer spinning processes, scratching, and polishing.

10. A method for evaluating process anomalies in a semiconductor manufacturing process, comprising:
generating a database of process anomalies, wherein the process anomalies are uncorrelated;
inspecting a wafer having at least one process anomaly; and
determining if the at least one process anomaly corresponds to a process anomaly in the database of process anomalies.

11. The method of claim 10, further including modifying the semiconductor manufacturing process if the at least one process anomaly of the inspected wafer corresponds to an anomaly in the database of process anomalies.

12. The method of claim 10, wherein the anomalies are uncategorized.

13. The method of claim 10, wherein inspecting the wafer includes creating a relational database of process anomalies and storing coordinates of process anomalies of a first defect and storing coordinates of process anomalies of a second defect.

14. The method of claim 13, further including creating a local density of defects for each wafer using one of a mathematical formulation or a stylus and a pad.

15. A method for determining the occurrence of an anomalous event, comprising:
storing a plurality of defect maps in a storage device;
creating a defect map of a recent anomalous event; and
determining if the defect map of the recent anomalous event corresponds to one of the plurality of defect maps in the storage device.

16. The method of claim 15, wherein the defect maps of the plurality of defect maps are uncorrelated and uncategorized.

17. The method of claim 15, further including modifying a process flow if the defect map of the recent anomalous event corresponds to one of the plurality of defect maps in the storage device.

18. The method of claim 15, wherein creating the defect map includes creating a relational database of defects.

19. The method of claim 18, further including storing coordinates of process signature of a first defect and storing coordinates of a process signature of a second defect, wherein the coordinates of the process signatures of the first and second defects are in relation to each other.

20. The method of claim 19, further including creating a local density of defects for each wafer using one of a mathematical formulation or a stylus and a pad.
